(19) United States
(12) Patent Application Publication
(10) Pub. No.: US 2022/0325613 A1
(43) Pub. Date: Oct. 13, 2022

(54) SYSTEM AND METHOD FOR PETROPHYSICAL MODELING AUTOMATION BASED ON MACHINE LEARNING

(71) Applicant: Saudi Arabian Oil Company, Dhahran (SA)

(72) Inventors: Chicheng Xu, Houston, TX (US); Weichang Li, Katy, TX (US); Majed Fareed Kanfar, Dammam (SA); Christon Achong, Dhahran (SA)

(21) Appl. No.: 17/715,208

(22) Filed: Apr. 7, 2022

Related U.S. Application Data
(60) Provisional application No. 63/172,291, filed on Apr. 8, 2021.

(51) Int. Cl. E21B 43/30; E21B 47/12; E21B 49/02; G06N 20/00

(52) U.S. Cl. CPC E21B 43/30; E21B 47/12; E21B 49/02; G06N 20/00

(57) ABSTRACT

Implementations provide a computer-implemented method that includes: accessing a first pool of input data encoding a plurality of petrophysical properties of a first set wells of a reservoir; performing one or more petro-rock type (PRT) labeling at least in part based on the first pool of input data; at least in part based on the one or more petro-rock type (PRT) labeling, training one or more models for the reservoir using one or more machine learning algorithms; accessing a second pool of input data encoding the plurality of petrophysical properties of a second set of wells of the reservoir, and applying the one or more models to a second pool of input data to determine a characteristic of the reservoir, wherein the second set of wells are different from the first set of wells.

### TECHNICAL FIELD

This disclosure generally relates to petrophysical reservoir characterization in the context of geo-exploration for oil and gas.

### BACKGROUND

Reservoir description can provide quantitative estimation of both the static reserve calculation and the dynamic reservoir production performance. By way of illustration, a reservoir description can feed a reservoir model with various petrophysical properties, including porosity, fluid saturation, permeability, capillary pressure, and relative permeability. Accurate estimation of petrophysical properties in drilled wells can form the basis for decision-making in reservoir management, ranging from drilling to production during field operations.

### SUMMARY

In one aspect, some implementations provide a computer-implemented method comprising: accessing a first pool of input data encoding a plurality of petrophysical properties of core samples extracted from a first set of wells of a reservoir; performing one or more petro-rock type (PRT) labeling at least based on the first pool of input data; at least based on the one or more petro-rock type (PRT) labeling, training one or more models for the reservoir using one or more machine learning algorithms; accessing a second pool of input data encoding the plurality of petrophysical properties of core samples extracted from a second set of wells of the reservoir; and applying the one or more models to the second pool of input data to determine a characteristic of the reservoir, wherein the second set of wells are different from the first set of wells.

Implementations may include one or more of the following features.

The first pool of input data may include more than one type of core data. The more than one type of core data may encode the plurality of petrophysical properties of core samples extracted from the reservoir. The one or more models may identify at least one correlation among the plurality of petrophysical properties. When applying the one or more models to the second pool of input data, the characteristic of the reservoir may be determined, at least in part, based on the at least one correlation. The petrophysical properties may include: a porosity, a permeability, a pore geometry, a capillary pressure, and a saturation height function.

The first pool of input data may include one or more measurement logs that encode petrophysical properties of rocks in boreholes drilled at the reservoir. The petrophysical properties may include: a porosity, a permeability, a pore geometry, a capillary pressure, and a saturation height function. The one or more machine learning algorithms may include: a support vector machine (SVM), a self-organizing map, a random forest, an artificial neural network, a convolutional neural network (CNN), a UNet, and a ResNet. The one or more models may be configured to perform at least one of: a regression, a classification, a clustering, or a segmentation. The characteristic of the reservoir may include: a reservoir reserve, or a reservoir production. The implementations may include validating the one or more models at least based on a testing pool of input data that is different from the first pool of input data.

In another aspect, some implementations provide computer system comprising one or more computer processors configured to perform operations of: accessing a first pool of input data encoding a plurality of petrophysical properties of core samples extracted from a first set of wells of a reservoir; performing one or more petro-rock type (PRT) labeling at least based on the first pool of input data; at least based on the one or more petro-rock type (PRT) labeling, training one or more models for the reservoir using one or more machine learning algorithms; accessing a second pool of input data encoding the plurality of petrophysical properties of core samples extracted from a second set of wells of the reservoir; and applying the one or more models to the second pool of input data to determine a characteristic of the reservoir, wherein the second set of wells are different from the first set of wells.

Implementations may include one or more of the following features.

The first pool of input data may include more than one type of core data. The more than one type of core data may encode the plurality of petrophysical properties of core samples extracted from the reservoir. The one or more models may identify at least one correlation among the plurality of petrophysical properties. When applying the one or more models to the second pool of input data, the characteristic of the reservoir may be determined, at least in part, based on the at least one correlation. The petrophysical properties may include: a porosity, a permeability, a pore geometry, a capillary pressure, and a saturation height function.

The first pool of input data may include one or more measurement logs that encode petrophysical properties of rocks in boreholes drilled at the reservoir. The petrophysical properties may include: a porosity, a permeability, a pore geometry, a capillary pressure, and a saturation height function. The one or more machine learning algorithms may include: a support vector machine (SVM), a self-organizing map, a random forest, an artificial neural network, a convolutional neural network (CNN), a UNet, and a ResNet. The one or more models may be configured to perform at least one of: a regression, a classification, a clustering, or a segmentation. The characteristic of the reservoir may include: a reservoir reserve, or a reservoir production. The implementations may include validating the one or more models at least based on a testing pool of input data that is different from the first pool of input data.

In yet another aspect, some implementations provide a non-transitory computer-readable medium comprising software instructions, which software instructions, when executed by a computer processor, causes the computer processor to perform operations of: accessing a first pool of input data encoding a plurality of petrophysical properties of core samples extracted from a first set of wells of a reservoir; performing one or more petro-rock type (PRT) labeling at least based on the first pool of input data; at least based on the one or more petro-rock type (PRT) labeling, training one or more models for the reservoir using one or more machine learning algorithms; accessing a second pool of input data encoding the plurality of petrophysical properties of core samples extracted from a second set of wells of the reservoir; and applying the one or more models to a second pool of input data to determine a characteristic of the reservoir, wherein the second set of wells are different from the first set of wells but are within the reservoir.

The implementations may include one or more of the following features.

The first pool of input data may include more than one type of core data. The more than one type of core data may encode the plurality of petrophysical properties of core samples extracted from the reservoir. The one or more models may identify at least one correlation among the plurality of petrophysical properties. When applying the one or more models to the second pool of input data, the characteristic of the reservoir may be determined, at least in part, based on the at least one correlation. The petrophysical properties may include: a porosity, a permeability, a pore geometry, a capillary pressure, and a saturation height function.

### DESCRIPTION OF DRAWINGS

FIG. 1 is a diagram illustrating reservoir description, reservoir modeling, and reservoir management.

FIG. 2 is another diagram illustrating the inter-correlation of various petrophysical parameters in the context of reservoir description.

FIG. 3A is yet another diagram illustrating an automatic and integrative workflow based on machine learning algorithms according to some implementations of the present disclosure.

FIG. 3B illustrates examples of discrete labeling at the core plugs level according to some implementations of the present disclosure.

FIG. 3C shows examples of continuous labeling with core photo, well log, and scans according to some implementations of the present disclosure.

FIG. 3D shows examples of using log-based clustering to detect petrophysical rock type (PRT) according to some implementations of the present disclosure.

FIG. 4 illustrates an example of fluid zone classification according to an implementations of the present disclosure.

FIG. 5A is a diagram of workflow of applying machine learning tools to build models for reservoir description according to some implementations of the present disclosure.

FIG. 5B is a flow chart according to an implementation of the present disclosure.

FIG. 6 shows a block diagram illustrating an example of a computer system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

Advanced petrophysical modeling can provide estimates of a plethora of petrophysical properties including, for example, porosity-permeability (phi-k), saturation height function (SHF), capillary pressure curve (CPC), and petrophysical rock types (PRT). Reservoir modelers can use these estimated petrophysical properties to characterize reserve and to forecast production at the reservoir. Those petrophysical properties are interconnected to each other through a multiple pore network system. Currently, these petrophysical parameters are processed sequentially from well logs and core analysis by human operators. The core analysis can include routine and special core analysis, and petrography. Moreover, insight from one discipline (for example, geological facies) typically does not map or scale appropriately to another discipline (for example, petrophysical rock types). Establishing the connections between these petrophysical parameters can allow these parameters to be scaled up from the fine scale of the pore system through the scale of core measurements and wireline logs. The challenge to establish the connections between the petrophysical parameters remains unaddressed. Implementations described by the present disclosure can address the challenge through the dynamic and simulation model scales. Significantly, implementations can leverage, for example, a correlation between these petrophysical parameters that quantify an interconnection between such parameters. The correlation can often times persist among physical wells in the same geological reservoir. As such, models trained based on input data from one group of wells in the reservoir can be applied to analyze input data from another group of wells in the same reservoir. Compared with conventional implementations that use Arps method and rely on decline curves to model production rates of oil and gas wells, the implementations include neither.

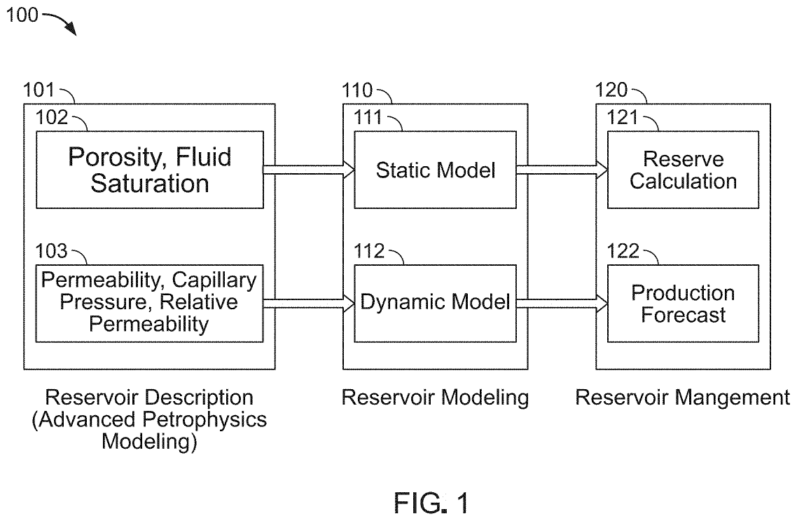

As illustrated in FIG. 1, diagram 100 illustrates reservoir description 101, reservoir modeling 110, and reservoir management 120. Reservoir description 101 can include the descriptions for porosity and fluid saturation 102 and permeability, capillary pressure, and relative permeability 103. Such descriptions may also be known as advanced petrophysics modeling. By way of examples, the advanced petrophysics modeling can mostly produce rock properties in wells while reservoir modeling can build a 3D earth model filled with rock properties. These descriptions can be provided to reservoir model 110. For example, porosity and fluid saturation 102 can be provided to static model 111. Permeability, capillary pressure, and relative permeability 103 can be provided to dynamic model 112. Reservoir modeling 110 can generate reserve calculation 121 and production forecast 122. For example, the static model 111 can generate reserve calculation 121, and the dynamic model 112 can generate production forecast 122.

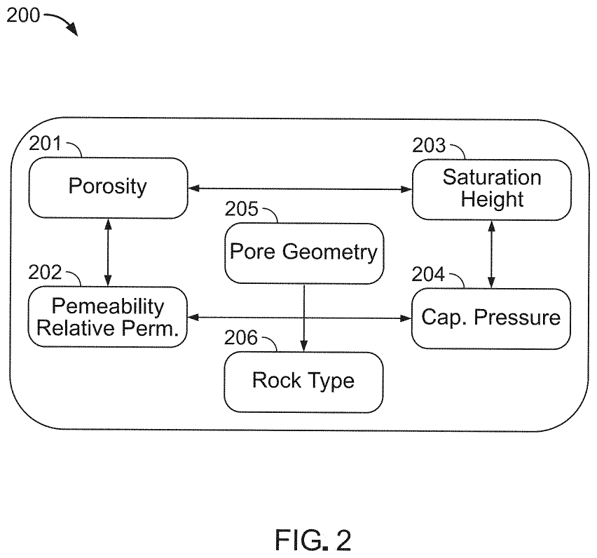

FIG. 2 is another diagram 200 illustrating the inter-correlation of various petrophysical parameters in the context of reservoir description. As illustrated, porosity 201 is inter-correlated with permeability or relative permeability 202. Porosity 201 is also inter-correlated with saturation height 203. Saturation height 203 is inter-correlated with capillary pressure 204. Capillary pressure is inter-correlated with permeability or relative permeability 202. Additionally, pore geometry 205 is inter-correlated with rock type 206.

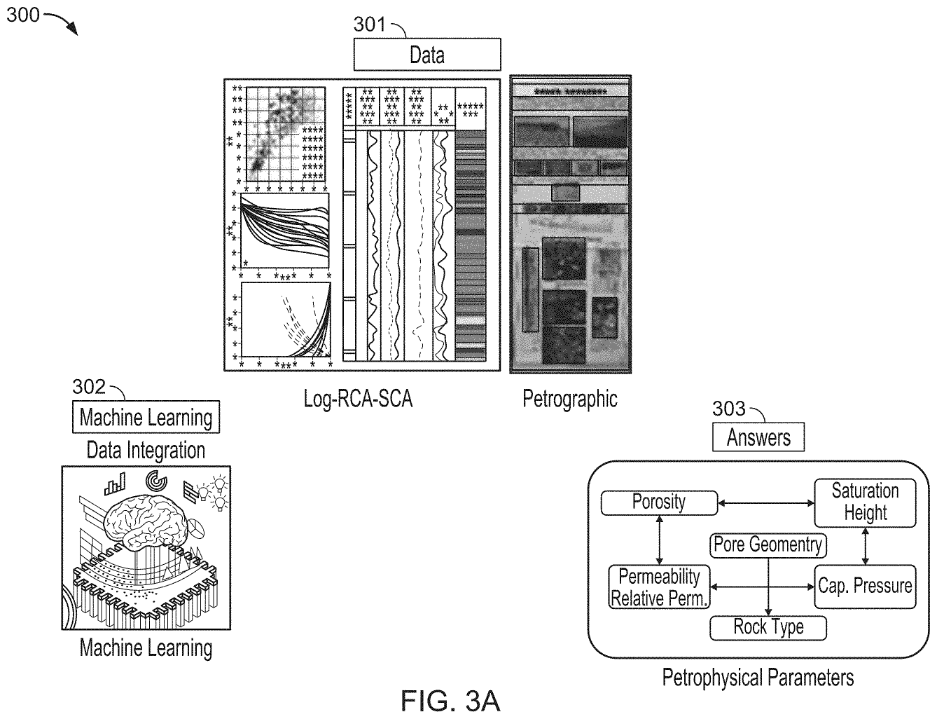

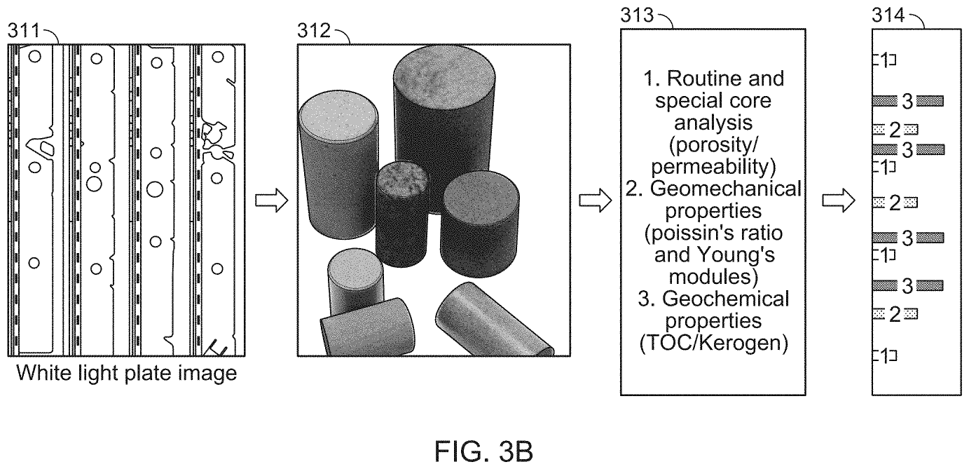

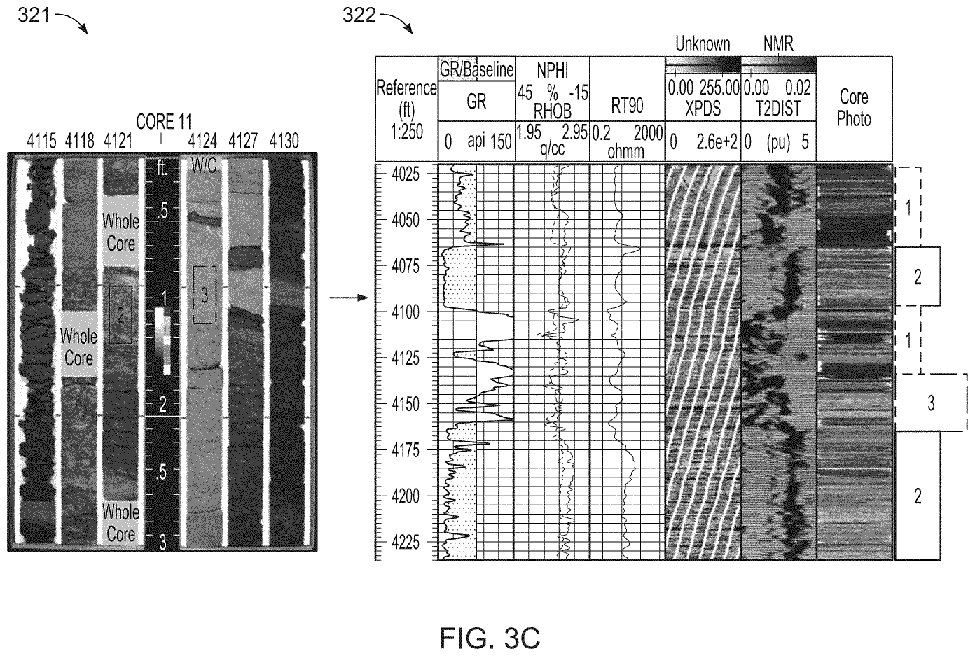

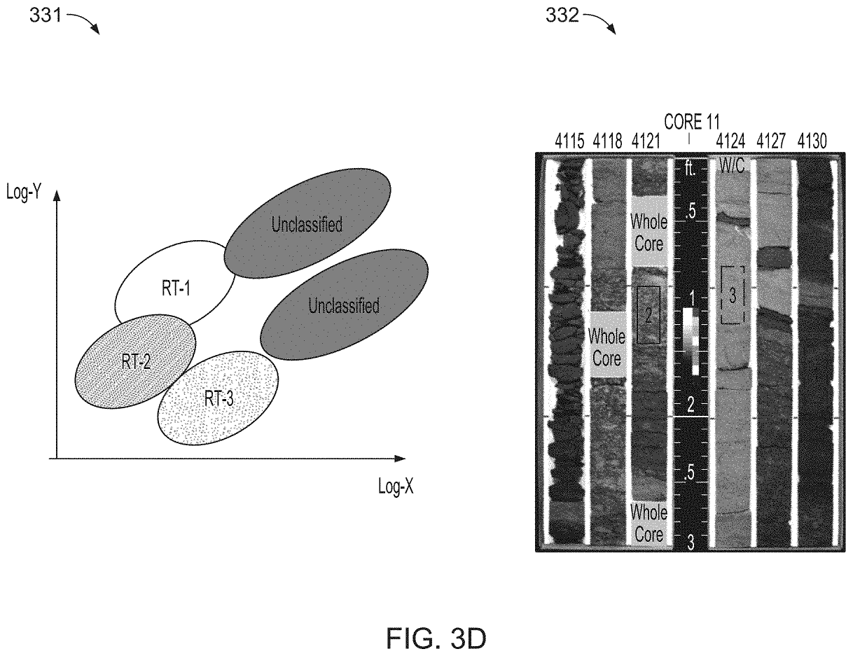

FIG. 3A is yet another diagram 300 illustrating an automatic and integrative workflow based on machine learning algorithms according to some implementations of the present disclosure. Here, the workflow can initially access data 301 which includes input core data and logs. Core data may refer to measurements performed on core samples taken from a well location. Examples of core data include routine core analysis (RCA) data, special core analysis (SCA) data, core petrography, and core logs or scans. RCA data may include porosity and permeability measurements. SCA data may include capillary pressure measurements, nuclear magnetic resonance spectroscopic data, relative permeability data, and X-Ray data (XRD). Core petrography data can include scanned electron microscopy (SEM) data, thin sections, and core photos. Core logs or scans may include gamma ray (GR) logs or CT scans. Logs may include conventional logs, advanced logs, and formation testing. Examples of logs include triple (or quadruple) combo. In some instances, the triple combo tool can acquire most of the basic petrophysical and lithological logs including, for example, density, porosity, resistivity, and gamma ray data. In these instances, the triple combo tool can also measure the borehole width, an important indicator of borehole and log quality. The quad combo tool can further include the sonic log. Advanced logs may include logs from more advanced logging tools such as nuclear magnetic resonance log, borehole image log, or elemental capture spectroscopy log. Examples of advanced logs may include: NMR logs, spectroscopy logs, borehole image. Notably, the NMR logs refer to NMR measurements acquired from downhole logs. While the core data may include NMR data of the core samples taken in a lab, the NMR data and the NMR logs are on different scales. Formation testing logs may generally refer to results of formation testing.

The workflow may then initiate machine learning algorithms 302 to build models based on data 301. For example, the workflow may use the input core data to train the models so that when the models are applied to newly available measurement data, an answer 303 can be generated regarding a characteristic of the reservoir. For example, a calculation can be made with regard to reservoir reserve, or a prediction can be made with regard to reservoir production. Examples of the answer can include: pore geometrical factors (PGF) & petrophysical rock types (PRT), porosity-permeability trend, capillary pressure, saturation height function, and relative permeability. As outlined in FIG. 2, these petrophysical properties can be inter-correlated.

In some implementations, the advanced petrophysical modeling can be formulated as a machine learning problem. The training set may include samples at various core points from the input data which are used to train the machine learning model. In one illustration, a deep neural network based regression model can be used to establish a mapping between the input measurements listed above and the output properties targeted by the petrophysical modeling process. Once the model has been trained based on the input training data and then validated based on, for example, validation data, the machine learning models can then be applied to predict, for example, porosity/permeability (phi-k), saturation height function (SHF), petrophysical rock type (PRT), simultaneously or individually, from new measurement data. In some cases, the input measurement data can include a full set of measurement data including core and logs. In other cases, the measurement data can include a partial set of data with different log settings, all under the constraint of a common pore system capable of determining the above petrophysical properties. The training and validation process will be conducted iteratively over a large number of wells with different petrophysical scenarios, to capture the representative features and petrophysical relationships.

Some implementations may apply the machine learning system can be applied for well log data. The scenarios where the machine learning system can be applied may generally include three tiers. In tier 1, the well has a complete logging suite that includes quad-combo/NMR/borehole image and basic or advanced core measurements. Here, the image refers to image data from the quad combo log, the NMR log, and the borehole log. In tier 2, the well has a complete logging suite only that includes, for example, quad-combo/NMR/image. In tier 3, the well may have only conventional logs that include, for example, triple combo to predict the targeted petrophysical properties.

The implementations provide an automatic and integrative workflow based on machine learning (ML) algorithms, which can be applied to the remaining wells in a field. The ML algorithms can treat the petrophysical parameters (e.g., phi-k, SHF, PRT) as one vector of output based on pore geometry. The implementations may leverage high quality data for the petrophysical modeling to yield satisfactory results. In other words, the implementations may be predicated on the input measurement data. Assuming the core data and well logs pass a quality control standard, the implementations may perform petrophysical rock types (PRT) labeling with core data based on pore geometry. Examples of pore geometry characteristics include: porosity-permeability, mercury injection capillary pressure, pressure-derived pore-throat size distribution, nuclear magnetic resonance (NMR) measurements (for example, in the form of 2D waveforms), image logging data, petrographic thin sections, and core photos.

Thereafter, the implementations may pursue core labeling guided log space clustering for validation of core labeled classes and identification of unlabeled new classes. The implementations may also augment PRT labeling (e.g., label for Tier 1) to cover, for example, uncored or bypassed classes (non-reservoirs), hybrid classes (mixed layers or heterogeneous), and fluid effect (e.g., an oil/water ratio).

As illustrated in FIGS. 3B to 3D, some implementations provide a labeling process as an progressive extension of labeling from discrete core plugs to continuous core interval and then to well log intervals. FIG. 3B illustrates examples of discrete labeling at the core plugs level according to some implementations of the present disclosure. White light plate images 311 can be associated with core samples 312. Each core sample can be analyzed. Data analysis 313 can include a first category of routine core analysis (RCA) and special core analysis (SCA), which can characterize porosity and permeability. Data analysis 313 can include a second category of geomechanical properties which can include the Poisson's ratio and Young's modulus. Data analysis 313 can include a third category of geochemical properties such as total organic carbon (TOC) and kerogen. A labeling (314) can be generated based on a combination of characteristics under the three categories. In panel 314, color and size of the bars represents different rock types from labeling.

FIG. 3C shows examples of continuous labeling with core photo, well log, and scans according to some implementations of the present disclosure. As illustrated in panel 321, rock types are being continuously labeled from core and well logs. Panel 321 specifically shows slabbed core in a box. Panel 322 shows well logs acquired from subsurface.

FIG. 3D shows examples of using log-based clustering to detect petro rock type (PRT) according to some implementations of the present disclosure. Notably, the log-based clustering in block 331 revealed three rock types, each corresponding to a rock type in block 332.

Based on the core labeling process, the implementations may perform well classification by data acquisition scenario. As revealed in Table 1, a tier 1 well has complete logging suite (quad-combo and NMR) and core data (label for Tier 2). A tier 2 well has complete logging suite only (quad-combo/NMR) (label for Tier 3). A tier 3 well has only conventional logs (triple combo).

TABLE 1

| Well | Triple Combo | Quad Combo | NMR | Core |
|---|---|---|---|---|
| Tier 1 | | Y | Y | Y |
| Tier 2 | | Y | Y | label |
| Tier 3 | Y (label) | | N | N |

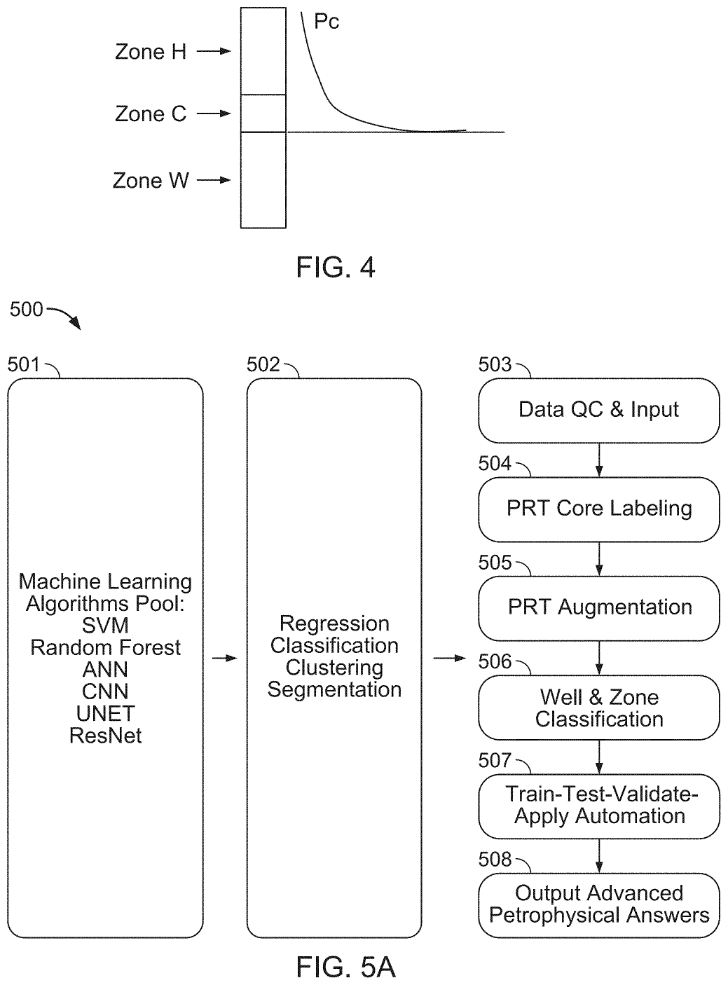

The implementations may then perform fluid zone classification that determines fluid effect on logs. The implementations may also determine fluid effect correction on logs (100% Sw). Here, Sw refers to water saturation. As illustrated by FIG. 4, implementations may determine hydrocarbon-bearing zone (gas or oil) with high Pc (almost irreducible water) (Zone H), capillary transition zone (Zone C), and water zone (Zone W). Here, Pc refers to capillary pressure.

For tier 1 wells with complete logging suite and core data, the implementations may pursue supervised learning using the core labels from core labeling guided log space clustering, as illustrated in, for example, FIG. 3D. For tier 2 wells with complete logging suite only, the implementations may pursue supervised learning using the classified results from tier 1 wells. For tier 3 wells with only conventional logs, the implementations may pursue supervised learning using the classification results from the tier 2 wells. In other words, the implementations may use different training data for different tiers of wells, as summarized in Table 2.

TABLE 2

| Well | Training Label |
|---|---|
| Tier 1 | Continuous core label |
| Tier 2 | All classified results from Tier 1 |
| Tier 3 | All classified results from Tier 2 |

The implementations may then pursue rock class based advanced petrophysical modeling to derive petrophysical parameters including, for example, porosity (in contrast to standard petrophysical analysis & RCA), irreducible water saturation (in contrast to standard petrophysical analysis), permeability (in contrast to NMR derived permeability and RCA analysis), saturation height model (in contrast to standard petrophysical analysis), and capillary pressure (in contrast to SCA). In some implementations, the advanced petrophysical modeling can be formulated as a regression problem (constrained by rock types) to model pore geometrical factors including: number of pore size modes, Thomeer's set [Pd, G, By], Gaussian mixture model [w, μ, σ]. As illustrated, these variables represent the parameters of a capillary pressure curve or its pore-size distribution function.

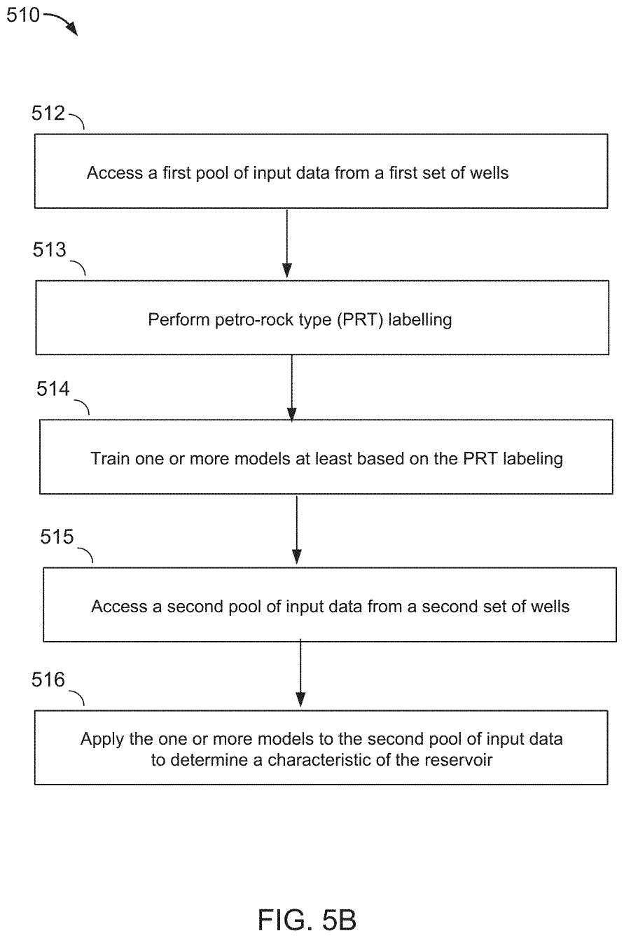

In some implementations, the machine learning based advanced petrophysical modeling software has multiple machine learning algorithms to choose from. As illustrated in diagram 500 of FIG. 5A, these ML algorithms may be selected from pool 501 that includes artificial neural network (ANN), convolutional neural network (CNN), support vector machine (SVM), self-organizing map (SOM), random forest (RF), UNet, and ResNet. These ML algorithms can couple to block 502 for subsequent regression, classification, clustering, and segmentation. The ML algorithms and regression/classification/clustering/ segmentation can power a workflow. The workflow may start from data quality control and access of input data (including, for example, core data and measurement logs) (503). The workflow may then proceed to petro rock type core labeling (504) followed by PRT augmentation (505). Results of PRT core labeling and augmentation may drive well & zone classification (506). The workflow may then pursue train-test-validation (507). In some cases, the implementations can automatically split data as training data and test set. In these cases, the implementations may then pursue hyperparameter tuning and avoid overfitting by monitoring training epochs. By way of background, as used in the context of machine learning, a hyperparameter is a parameter whose value is used to control the learning process. By contrast, the values of other parameters (typically node weights) are derived via training. As described earlier, various implementations may use different training-test-validation process for different tiers of wells in different fluid zones. The petrophysical rock properties and rock classes obtained from all drilled wells may then be used to populate a 3D reservoir model. Based on this 3D reservoir model, reservoir reserve can be calculated and reservoir production can be predicted, and advanced petrophysical answers can be generated as the output (508).

As illustrated in FIG. 5B, a flow chart 510 for some implementations may initially access a first pool of input data from a first set of wells (512). The first pool of input data may encode multiple petrophysical properties of the first set of wells. Examples of the petrophysical properties can include: a porosity, a permeability, a pore geometry, a capillary pressure, and a saturation height function. The implementations may then perform petro-rock type (PRT) labeling at least in part based on the first pool of input data (513). The first pool of input data may also include one or more measurement logs wherein the one or more measurement logs encode petrophysical properties of rocks in boreholes drilled at the reservoir. The implementations may then train one or more models at least based on the PRT labeling, using one or more machine learning algorithms (514). The one or more machine learning algorithms can include: a support vector machine (SVM), a self-organizing map, a random forest, an artificial neural network, a convolutional neural network (CNN), a UNet, and a ResNet. The one or more models can be configured to perform at least one of: a regression, a classification, a clustering, or a segmentation. The implementations may then access a second pool of input data from a second set of wells from the same reservoir (515). The second set of wells may be different from the first set of wells. Thereafter, the implementation may apply the one or more models to the second pool of input data to determine a characteristic of the reservoir (516). Examples of characteristic of the reservoir can include a reservoir reserve, or a reservoir production. The implementations may further include validating the one or more models at least based on a testing pool of input data different from the first pool of input data.

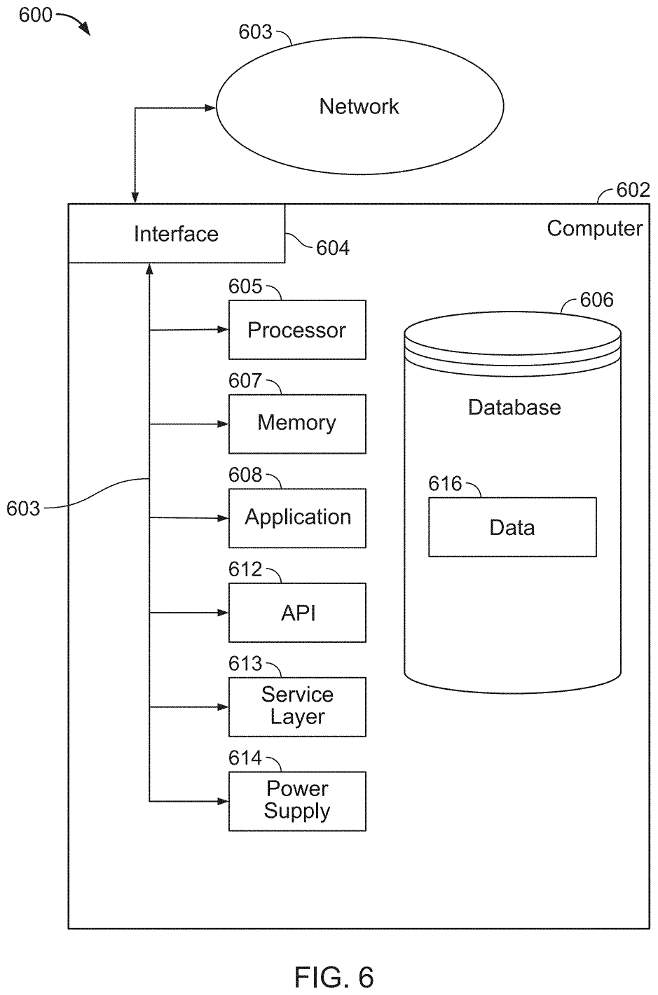

FIG. 6 is a block diagram illustrating an example of a computer system 600 used to provide computational functionalities associated with described algorithms, methods, functions, processes, flows, and procedures, according to an implementation of the present disclosure. The illustrated computer 602 is intended to encompass any computing device such as a server, desktop computer, laptop/notebook computer, wireless data port, smart phone, personal data assistant (PDA), tablet computing device, one or more processors within these devices, another computing device, or a combination of computing devices, including physical or virtual instances of the computing device, or a combination of physical or virtual instances of the computing device. Additionally, the computer 602 can comprise a computer that includes an input device, such as a keypad, keyboard, touch screen, another input device, or a combination of input devices that can accept user information, and an output device that conveys information associated with the operation of the computer 602, including digital data, visual, audio, another type of information, or a combination of types of information, on a graphical-type user interface (UI) (or GUI) or other UI.

The computer 602 can serve in a role in a computer system as a client, network component, a server, a database or another persistency, another role, or a combination of roles for performing the subject matter described in the present disclosure. The illustrated computer 602 is communicably coupled with a network 603. In some implementations, one or more components of the computer 602 can be configured to operate within an environment, including cloud-computing-based, local, global, another environment, or a combination of environments.

The computer 602 is an electronic computing device operable to receive, transmit, process, store, or manage data and information associated with the described subject matter. According to some implementations, the computer 602 can also include or be communicably coupled with a server, including an application server, e-mail server, web server, caching server, streaming data server, another server, or a combination of servers.

The computer 602 can receive requests over network 603 (for example, from a client software application executing on another computer 602) and respond to the received requests by processing the received requests using a software application or a combination of software applications. In addition, requests can also be sent to the computer 602 from internal users, external or third-parties, or other entities, individuals, systems, or computers.

Each of the components of the computer 602 can communicate using a system bus 603. In some implementations, any or all of the components of the computer 602, including hardware, software, or a combination of hardware and software, can interface over the system bus 603 using an application programming interface (API) 612, a service layer 613, or a combination of the API 612 and service layer 613. The API 612 can include specifications for routines, data structures, and object classes. The API 612 can be either computer-language independent or dependent and refer to a complete interface, a single function, or even a set of APIs. The service layer 613 provides software services to the computer 602 or other components (whether illustrated or not) that are communicably coupled to the computer 602. The functionality of the computer 602 can be accessible for all service consumers using this service layer. Software services, such as those provided by the service layer 613, provide reusable, defined functionalities through a defined interface. For example, the interface can be software written in JAVA, C++, another computing language, or a combination of computing languages providing data in extensible markup language (XML) format, another format, or a combination of formats. While illustrated as an integrated component of the computer 602, alternative implementations can illustrate the API 612 or the service layer 613 as stand-alone components in relation to other components of the computer 602 or other components (whether illustrated or not) that are communicably coupled to the computer 602. Moreover, any or all parts of the API 612 or the service layer 613 can be implemented as a child or a sub-module of another software module, enterprise application, or hardware module without departing from the scope of the present disclosure.

The computer 602 includes an interface 604. Although illustrated as a single interface 604 in FIG. 6, two or more interfaces 604 can be used according to particular needs, desires, or particular implementations of the computer 602. The interface 604 is used by the computer 602 for communicating with another computing system (whether illustrated or not) that is communicatively linked to the network 603 in a distributed environment. Generally, the interface 604 is operable to communicate with the network 603 and comprises logic encoded in software, hardware, or a combination of software and hardware. More specifically, the interface 604 can comprise software supporting one or more communication protocols associated with communications such that the network 603 or interface's hardware is operable to communicate physical signals within and outside of the illustrated computer 602.

The computer 602 includes a processor 605. Although illustrated as a single processor 605 in FIG. 6, two or more processors can be used according to particular needs, desires, or particular implementations of the computer 602. Generally, the processor 605 executes instructions and manipulates data to perform the operations of the computer 602 and any algorithms, methods, functions, processes, flows, and procedures as described in the present disclosure.

The computer 602 also includes a database 606 that can hold data for the computer 602, another component communicatively linked to the network 603 (whether illustrated or not), or a combination of the computer 602 and another component. For example, database 606 can be an in-memory, conventional, or another type of database storing data consistent with the present disclosure. In some implementations, database 606 can be a combination of two or more different database types (for example, a hybrid in-memory and conventional database) according to particular needs, desires, or particular implementations of the computer 602 and the described functionality. Although illustrated as a single database 606 in FIG. 6, two or more databases of similar or differing types can be used according to particular needs, desires, or particular implementations of the computer 602 and the described functionality. While database 606 is illustrated as an integral component of the computer 602, in alternative implementations, database 606 can be external to the computer 602. As illustrated, the database 606 holds the previously described data 616 including, for example, multiple streams of data from various sources, such as the training data, the validation data, and the testing data from the inspection logs and the labeling database.

The computer 602 also includes a memory 607 that can hold data for the computer 602, another component or components communicatively linked to the network 603 (whether illustrated or not), or a combination of the computer 602 and another component. Memory 607 can store any data consistent with the present disclosure. In some implementations, memory 607 can be a combination of two or more different types of memory (for example, a combination of semiconductor and magnetic storage) according to particular needs, desires, or particular implementations of the computer 602 and the described functionality. Although illustrated as a single memory 607 in FIG. 6, two or more memories 607 or similar or differing types can be used according to particular needs, desires, or particular implementations of the computer 602 and the described functionality. While memory 607 is illustrated as an integral component of the computer 602, in alternative implementations, memory 607 can be external to the computer 602.

The application 608 is an algorithmic software engine providing functionality according to particular needs, desires, or particular implementations of the computer 602, particularly with respect to functionality described in the present disclosure. For example, application 608 can serve as one or more components, modules, or applications. Further, although illustrated as a single application 608, the application 608 can be implemented as multiple applications 608 on the computer 602. In addition, although illustrated as integral to the computer 602, in alternative implementations, the application 608 can be external to the computer 602.

The computer 602 can also include a power supply 614. The power supply 614 can include a rechargeable or non-rechargeable battery that can be configured to be either user- or non-user-replaceable. In some implementations, the power supply 614 can include power-conversion or management circuits (including recharging, standby, or another power management functionality). In some implementations, the power-supply 614 can include a power plug to allow the computer 602 to be plugged into a wall socket or another power source to, for example, power the computer 602 or recharge a rechargeable battery.

There can be any number of computers 602 associated with, or external to, a computer system containing computer 602, each computer 602 communicating over network 603. Further, the term “client,” “user,” or other appropriate terminology can be used interchangeably, as appropriate, without departing from the scope of the present disclosure. Moreover, the present disclosure contemplates that many users can use one computer 602, or that one user can use multiple computers 602.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal, for example, a machine-generated electrical, optical, or electromagnetic signal that is generated to encode information for transmission to a receiver apparatus for execution by a data processing apparatus. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be, or further include special purpose logic circuitry, for example, a central processing unit (CPU), an FPGA (field programmable gate array), or an ASIC (application-specific integrated circuit). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with an operating system of some type, for example LINUX, UNIX, WINDOWS, MAC OS, ANDROID, IOS, another operating system, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and apparatus can also be implemented as, special purpose logic circuitry, for example, a CPU, an FPGA, or an ASIC.

Computers for the execution of a computer program can be based on general or special purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device.

Non-transitory computer-readable media for storing computer program instructions and data can include all forms of media and memory devices, magnetic devices, magneto optical disks, and optical memory device. Memory devices include semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Magnetic devices include, for example, tape, cartridges, cassettes, internal/removable disks. Optical memory devices include, for example, digital video disc (DVD), CD-ROM, DVD+/−R, DVD-RAM, DVD-ROM, HD-DVD, and BLURAY, and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special purpose logic circuitry.

To provide for interaction with a user, implementations of the subject matter described in this specification can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity, a multi-touch screen using capacitive or electric sensing, or another type of touchscreen. Other types of devices can be used to interact with the user. For example, feedback provided to the user can be any form of sensory feedback. Input from the user can be received in any form, including acoustic, speech, or tactile input. In addition, a computer can interact with the user by sending documents to and receiving documents from a client computing device that is used by the user.

The term “graphical user interface,” or “GUI,” can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with the present disclosure), all or a portion of the Internet, another communication network, or a combination of communication networks. The communication network can communicate with, for example, Internet Protocol (IP) packets, Frame Relay frames, Asynchronous Transfer Mode (ATM) cells, voice, video, data, or other information between networks addresses.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what can be claimed, but rather as descriptions of features that can be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method comprising:
accessing a first pool of input data encoding a plurality of petrophysical properties of core samples extracted from a first set of wells of a reservoir;
performing one or more petro-rock type (PRT) labeling at least based on the first pool of input data;
at least based on the one or more petro-rock type (PRT) labeling, training one or more models for the reservoir using one or more machine learning algorithms;
accessing a second pool of input data encoding the plurality of petrophysical properties of core samples extracted from a second set of wells of the reservoir; and
applying the one or more models to the second pool of input data to determine a characteristic of the reservoir, wherein the second set of wells are different from the first set of wells.

2. The computer-implemented method of claim 1, wherein the first pool of input data include more than one type of core data,
wherein the more than one type of core data encode the plurality of petrophysical properties of core samples extracted from the reservoir,
wherein the one or more models identify at least one correlation among the plurality of petrophysical properties, and
wherein, when applying the one or more models to the second pool of input data, the characteristic of the reservoir is determined, at least in part, based on the at least one correlation.

3. The computer-implemented method of claim 2, wherein the petrophysical properties comprise: a porosity, a permeability, a pore geometry, a capillary pressure, and a saturation height function.

4. The computer-implemented method of claim 1, wherein the first pool of input data include one or more measurement logs wherein the one or more measurement logs encode petrophysical properties of rocks in boreholes drilled at the reservoir.

5. The computer-implemented method of claim 4, wherein the petrophysical properties comprise: a porosity, a permeability, a pore geometry, a capillary pressure, and a saturation height function.

6. The computer-implemented method of claim 1, wherein the one or more machine learning algorithms comprise: a support vector machine (SVM), a self-organizing map, a random forest, an artificial neural network, a convolutional neural network (CNN), a UNet, and a ResNet.

7. The computer-implemented method of claim 1, wherein the one or more models are configured to perform at least one of: a regression, a classification, a clustering, or a segmentation.

8. The computer-implemented method of claim 1, wherein the characteristic of the reservoir includes: a reservoir reserve, or a reservoir production.

9. The computer-implemented method of claim 1, further comprising:
validating the one or more models at least based on a testing pool of input data, wherein the testing pool of input data is different from the first pool of input data.

10. A computer system comprising one or more computer processors configured to perform operations of:
accessing a first pool of input data encoding a plurality of petrophysical properties of core samples extracted from a first set of wells of a reservoir;
performing one or more petro-rock type (PRT) labeling at least based on the first pool of input data;
at least based on the one or more petro-rock type (PRT) labeling, training one or more models for the reservoir using one or more machine learning algorithms;
accessing a second pool of input data encoding the plurality of petrophysical properties of core samples extracted from a second set of wells of the reservoir; and
applying the one or more models to a second pool of input data to determine a characteristic of the reservoir, wherein the second set of wells are different from the first set of wells.

11. The computer system of claim 10, wherein the first pool of input data include more than one type of core data,
wherein the more than one type of core data encode the plurality of petrophysical properties of core samples extracted from a reservoir,
wherein the one or more models identify at least one correlation among the plurality of petrophysical properties, and
wherein, when applying the one or more models to the second pool of input data, the characteristic of the reservoir is determined, at least in part, based on the at least one correlation.

12. The computer system of claim 11, wherein the petrophysical properties comprise: a porosity, a permeability, a pore geometry, a capillary pressure, and a saturation height function.

13. The computer system of claim 10, wherein the first pool of input data include one or more measurement logs wherein the one or more measurement logs encode petrophysical properties of rocks in boreholes drilled at the reservoir.

14. The computer system of claim 13, wherein the petrophysical properties comprise: a porosity, a permeability, a pore geometry, a capillary pressure, and a saturation height function.

15. The computer system of claim 10, wherein the one or more machine learning algorithms comprise: a support vector machine (SVM), a self-organizing map, a random forest, an artificial neural network, a convolutional neural network (CNN), a UNet, and a ResNet.

16. The computer system of claim 10, wherein the one or more models are configured to perform at least one of: a regression, a classification, a clustering, or a segmentation.

17. The computer system of claim 10, wherein the characteristic of the reservoir includes: a reservoir reserve, or a reservoir production.

18. The computer system of claim 10, wherein the operations further comprise:
validating the one or more models at least based on a testing pool of input data, wherein the testing pool of input data is different from the first pool of input data.

19. A non-transitory computer-readable medium comprising software instructions, which software instructions, when executed by a computer processor, causes the computer processor to perform operations of:
accessing a first pool of input data encoding a plurality of petrophysical properties of core samples extracted from a first set of wells of a reservoir;
performing one or more petro-rock type (PRT) labeling at least based on the first pool of input data;
at least based on the one or more petro-rock type (PRT) labeling, training one or more models for the reservoir using one or more machine learning algorithms;
accessing a second pool of input data encoding the plurality of petrophysical properties of core samples extracted from a second set of wells of the reservoir; and
applying the one or more models to a second pool of input data to determine a characteristic of the reservoir, wherein the second set of wells that are different from the first set of wells but are within the reservoir.

20. The non-transitory computer-readable medium of claim 19, wherein the first pool of input data include more than one type of core data,
wherein the more than one type of core data encode the plurality of petrophysical properties of core samples extracted from a reservoir,
wherein the one or more models identify at least one correlation among the plurality of petrophysical properties, and
wherein, when applying the one or more models to the second pool of input data, the characteristic of the reservoir is determined, at least in part, based on the at least one correlation.
